(19) United States
(12) Patent Application Publication
(10) Pub. No.: US 2017/0134062 A1
(43) Pub. Date: May 11, 2017

(54) Cell Phone Case With Pocket System

(71) Applicant: Patricia Erickson, Winnetka, IL (US)

(72) Inventor: Patricia Erickson, Winnetka, IL (US)

(21) Appl. No.: 15/165,801

(22) Filed: May 26, 2016

Related U.S. Application Data
(60) Provisional application No. 62/252,992, filed on Nov. 9, 2015.

(51) Int. Cl. H04B 1/3888; H04M 1/02

(52) U.S. Cl. CPC H04B 1/3888; H04M 1/0202; H04B 2001/3894

(57) ABSTRACT

A cell phone case with pocket system for cell phone protection and storage for personal items. The cell phone case with pocket assembly may have a cell phone receiver and a cell phone cover. The cell phone receiver may be a plurality of colors, useful for aesthetic pleasure. The cell phone receiver may have a plurality of designs, useful for ready recognition the user's the cell phone. The outer surface may have a pocket and an identifying label. The pocket may have a volume for retaining a credit card, money, and alternately a set of keys. The cell phone cover may include a transparent window and cell phone tactile-function-enabling materials. The cell phone receiver and the cell phone cover are structured and arranged to enclose a cell phone in a waterproof closure, while allowing the user to store items in the pocket, and apply an identifying label.

### CROSS-REFERENCE TO RELATED APPLICATION

The present application is related to and claims priority from prior provisional application Ser. No. 62/252,992, filed Nov. 9, 2015 which application is incorporated herein by reference.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of protective devices and more specifically relates to a cell phone case with pocket system.

2. Description of Related Art

When a person is rushing out the door the last thing they want to do is spend extra time making sure they have all of their personal effects. Money? Credit Card? Keys? Phone? Traditionally a person would put all these items inside a purse or bag, but a person doesn't always want to have to carry around such an item when venturing out, especially to crowded environments where a purse or bag would be cumbersome or even prohibited, like a club or sporting event. Furthermore, some outfits don't have pockets large enough to fit all these personal effects. In addition, a person may be going to an environment where water is present, such as a trip to the beach or to a pool. Getting a cellphone wet generally renders it unusable. A suitable solution is desirable.

Several attempts have been made to solve the above-mentioned problems such as those found in U.S. Pat and Pub. Nos. 2012/0021810 to Terry; 2014/0051488 to Chung; 9,049,283 to Kim; 2014/0367004 to Miki; 2011/0284407 to Connolly; and 2008/0121322 to Thompson. This art is representative of protective devices. However, none of the above inventions and patents, taken either singly or in combination, is seen to describe the invention as claimed.

Preferably, a protective device should provide cell phone protection and storage for personal items and, yet would operate reliably and be manufactured at a modest expense. Thus, a need exists for a reliable cell phone case with pocket system to avoid the above-mentioned problems.

### BRIEF SUMMARY OF THE INVENTION

In view of the foregoing disadvantages inherent in the known protective device art, the present invention provides a novel cell phone case with pocket system. The general purpose of the present invention, which will be described subsequently in greater detail is to provide cell phone protection and storage for personal items.

The cell phone case with pocket system as disclosed herein, in a preferred embodiment, may comprise a cell phone case with pocket assembly. The cell phone case with pocket assembly may comprise a cell phone receiver and a cell phone cover. The cell phone receiver and the cell phone cover are structured and arranged in combination to removably enclose a cell phone in a waterproof closure, while allowing the user to store a plurality of items in the pocket, and apply a label with indicia.

The cell phone receiver may comprise an inner volume and an outer surface. The cell phone receiver may comprise a plurality of colors, useful for aesthetic pleasure of the user. The cell phone receiver may further comprise a plurality of designs, useful for ready recognition of proximity of the user's the cell phone. The inner volume of the cell phone receiver may comprise a depth. The inner volume of the cell phone receiver may comprise a width. Further, the inner volume of the cell phone receiver may comprise a height. The depth, width, and height of the inner volume are structured and arranged to removably couple with a cell phone.

The outer surface may comprise protective-materials useful for protecting the cell phone from damage when dropped. The outer surface may further comprise a pocket, a camera-window, and a label. The pocket may comprise a volume, useful for retaining a credit card, money, and alternately a set of keys. The camera window may comprise a clear lens, useful for allowing a user to take photographs when the outer surface is coupled with a cell phone. The label may comprise indicia. The indicia may comprise personalized labeling, useful for ready identification of the user of the cell phone.

The cell phone cover may comprise a transparent window and cell phone tactile-function-enabling materials. The transparent window may comprise see-through-plastic-materials, useful for allowing the user to view displays on the cell phone. The cell phone tactile-function-enabling-materials comprise an interface for the user to access the cell phone. The cell phone cover may be removably attachable to the cell phone receiver, useful for providing the waterproof enclosure for the cell phone. The cell phone cover, in an installed condition, may be in parallel configuration to the cell phone.

The cell phone case with pocket system may further comprise a kit including the cell phone case with pocket assembly, and a set of user instructions. A method of using a cell phone case with pocket system may comprise the steps of inserting a cell phone in a cell phone receiver, enclosing the cell phone with a cell phone cover, and placing a credit card, money, and alternately a set of keys in a pocket, removing the credit card, the money, and alternately the set of keys in the pocket as desired, and using the cell phone for communications. The method of use may further comprise the step of removing the cell phone from the cell phone receiver when desired.

The present invention holds significant improvements and serves as a cell phone case with pocket system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, cell phone case with pocket system, constructed and operative according to the teachings of the present invention.

FIG. 1 shows a perspective view illustrating a cell phone case with pocket system during an ‘in-use’ condition showing cell phone case with pocket assembly according to an embodiment of the present invention.

FIG. 2A shows a perspective view of the cell phone case with pocket assembly comprising a cell phone receiver and cell phone cover according to an embodiment of the present invention of FIG. 1.

FIG. 2B, show a perspective view of the cell phone case with pocket assembly comprising a cell phone receiver and cell phone cover according to an embodiment of the present invention of FIG. 1.

FIG. 3 is an exploded view of the cell phone case with pocket assembly according to an embodiment of the present invention of FIGS. 1-2.

FIG. 4 illustrates alternate uses for pocket of cell phone case with pocket assembly according to an embodiment of the present invention of FIGS. 1-3.

FIG. 5 is a flowchart illustrating a method of use for the cell phone case with pocket assembly according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to protective devices and more particularly to a cell phone case with pocket system as used to improve cell phone protection and storage for personal items.

Generally speaking, the present invention virtually eliminates the need to carry a separate wallet or purse. The individual places a pocket directly inside a cell phone case, for ease of use. The device effectively ensures that a person is never stranded without money. The present invention contains a small opening for personalized labeling and is offered in a wide variety of colors and patterns to suit consumer taste. The apparatus offers an alternate version capable of accommodating iPads and other larger electronic devices. Cell phone case with pocket is a protective cell phone case with a small storage pocket.

This innovative product may comprise a waterproof plastic or similar material case that may fit snugly around a cell phone and protect it from damage if dropped. The case may surround the back and side portions of a cell phone and there may be another transparent covering for the screen portion. Both portions may be waterproof and can the entire product may float if submerged in water. There may a small, waterproof pocket on the outside of the case wherein money, keys, credit cards, and other small personal effects may be stored. There can also be a small window below the pocket where a person can insert a decorative element such as a nameplate or title. Further, there can be an attachment for the case which allows the user to wear the device around their neck. Cell phone case with pocket may vary in size to accommodate all types of cell phones. It may also be available in a wide variety of patterns and colors.

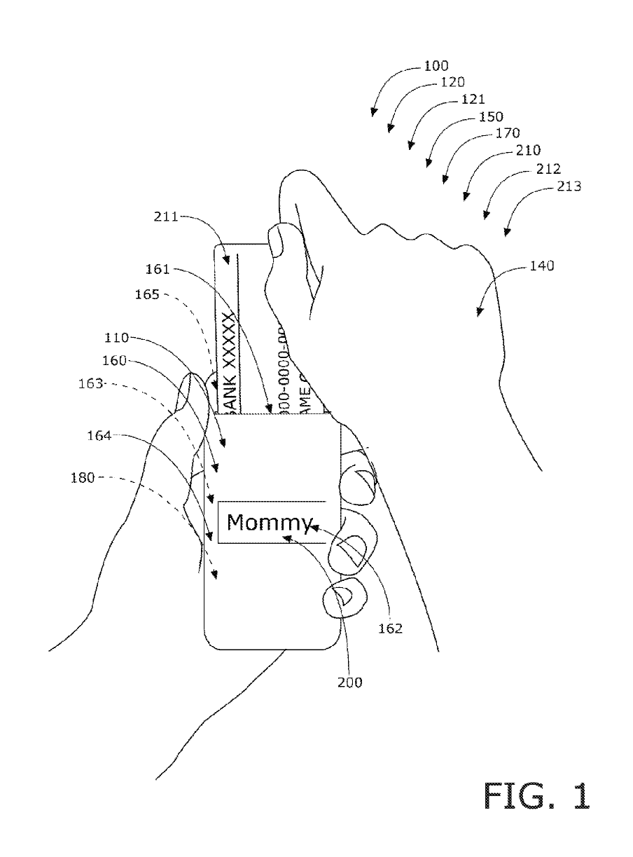

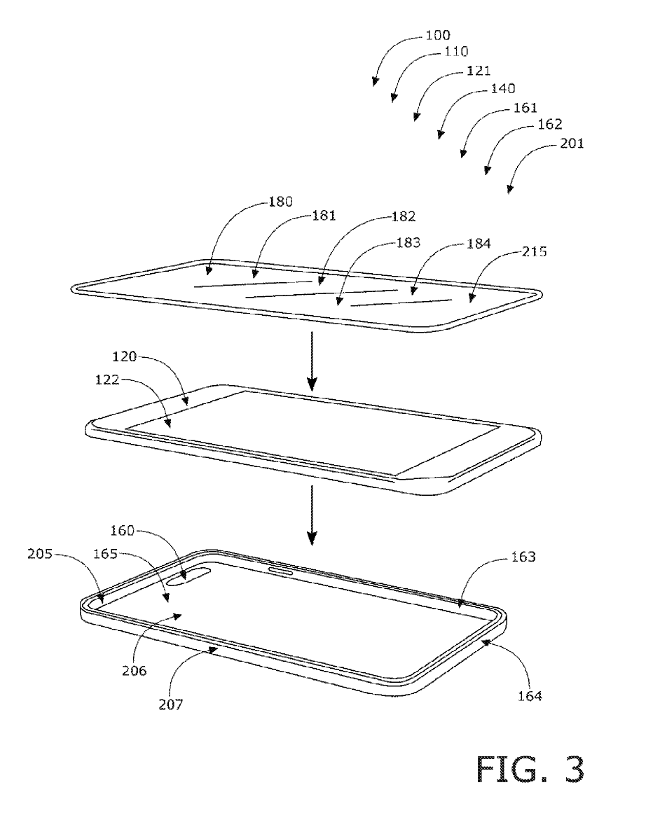

Referring to the drawings by numerals of reference there is shown in FIG. 1, a cell phone case with pocket system 100 during an ‘in-use’ condition 150, showing user 140 retaining credit card 211 in pocket 161 of cell phone case with pocket assembly 110. Cell phone case with pocket system 100 may comprise cell phone case with pocket assembly 110. Cell phone case with pocket assembly 110 may comprise cell phone receiver 160 and cell phone cover 180 (FIG. 3). Cell phone receiver 160 and cell phone cover 180 are structured and arranged in combination to removably enclose cell phone 120 in waterproof enclosure 121, while allowing user 140 to store plurality of items 170 in a pocket 161, and apply a label 162 with indicia 200.

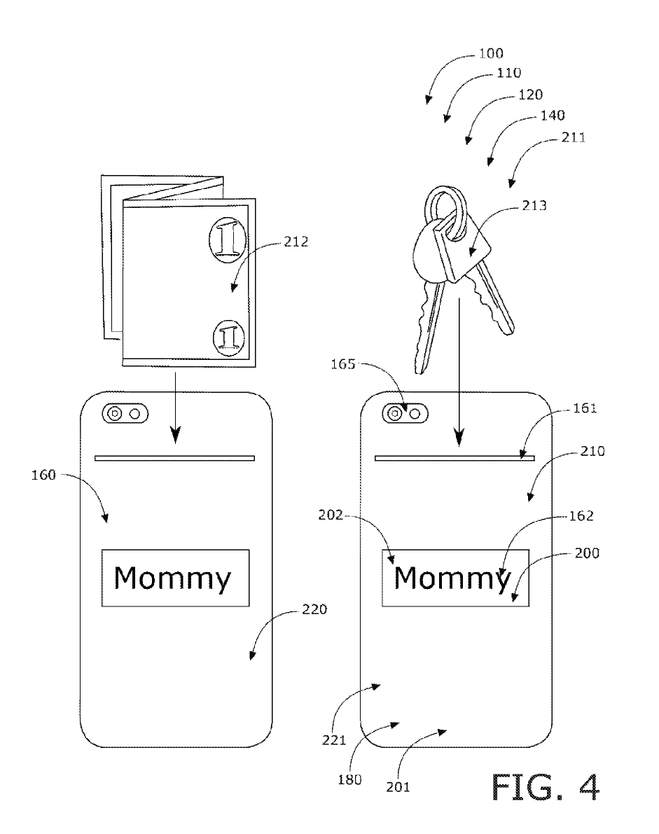

Cell phone receiver 160 may comprise inner volume 163 (FIG. 3), and outer surface 164. Outer surface 164 may comprise pocket 161, camera-window 165, and label 162 with indicia 200. Pocket 161 may comprise volume 210, useful for retaining credit card 211, money 212, and alternately a set of keys 213 (as shown in FIG. 4).

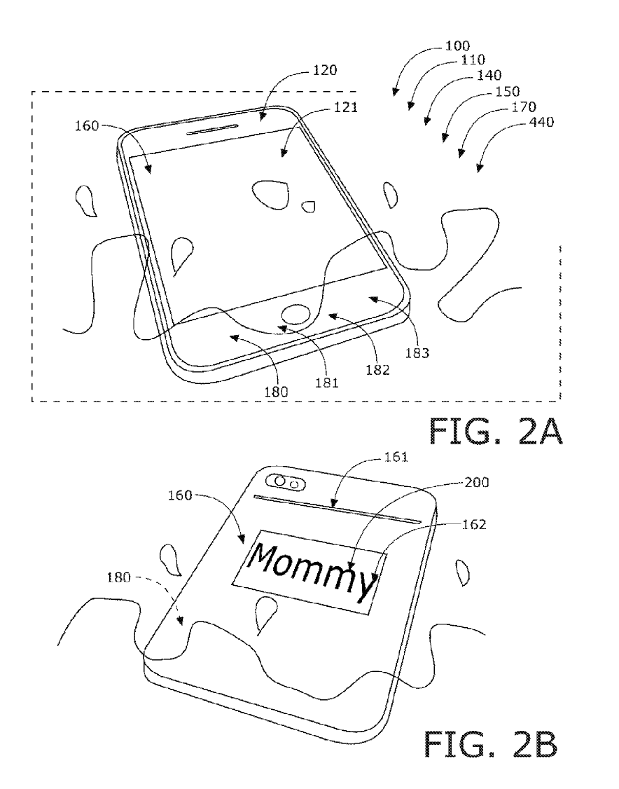

Referring now to FIGS. 2A and 2B, perspective views of cell phone case with pocket assembly 110. FIG. 2A is a perspective view of cell phone cover 180, in an installed condition. Cell phone cover 180 may be in parallel configuration 183 to cell phone 120. Cell phone cover 180 may be removably attachable to cell phone receiver 160 (FIG. 2B), useful for providing waterproof enclosure 121 for cell phone 120. Further, cell phone cover 180 may comprise transparent window 181, and cell phone tactile-function-enabling-materials 182.

Referring now to FIG. 2B, cell phone receiver 160 and cell phone cover 180 (FIG. 2A) are structured and arranged in combination to removably enclose cell phone 120 (FIG. 2A) in waterproof enclosure 121 while allowing user 140 (FIG. 1) to store a plurality of items 170 (FIG. 1) in pocket 161 and apply label 162 with indicia 200.

Referring now to FIG. 2B, it should be noted that cell phone case with pocket system 100 (FIG. 1) may be arranged as kit comprising the following parts: at least one cell phone case with pocket assembly 110; and at least one set of user instructions 440. The kit has instructions such that functional relationships are detailed in relation to the structure of the invention (such that the invention can be used, maintained, or the like in a preferred manner). The cell phone case with pocket system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

Referring now to FIG. 3, an exploded view of a cell phone case with pocket assembly 110 is shown. Cell phone case with pocket system 100 may comprise cell phone case with pocket assembly 110. Cell phone case with pocket assembly 110 may comprise cell phone receiver 160 and cell phone cover 180. Cell phone receiver 160 may comprise inner volume 163 and outer surface 164. Inner volume 163 of cell phone receiver 160 may comprise depth 205. Inner volume 163 of cell phone receiver 160 may comprise width 206. Inner volume 163 of cell phone receiver 160 may comprise height 207. Depth 205, width 206, and height 207 of inner volume 163 are structured and arranged to removably couple with cell phone 120. Outer surface 164 may comprise pocket 161 (FIG. 1), camera-window 165, and label 162 (FIG. 1). Outer surface 164 may further comprise protective-materials 201 useful for protecting cell phone 120 from damage when dropped.

Cell phone cover 180 may comprise transparent window 181 and cell phone tactile-function-enabling materials 182. Transparent window 181 may further comprise see-through-plastic-materials 215, useful for allowing user 140 (FIG. 1) to view one or more displays 122 on cell phone 120. Cell phone tactile-function-enabling-materials 182 comprise interface 184 for user 140 to access cell phone 120. Cell phone cover 180 may be removably attachable to cell phone receiver 160, useful for providing waterproof enclosure 121 for cell phone 120. Cell phone cover 180, in an installed condition, may be in parallel configuration 183 to cell phone 120.

Referring now to FIG. 4, shows alternate uses for pocket 161 of cell phone case with pocket assembly 110. As above, cell phone receiver 160 may comprise inner volume 163 and outer surface 164. Outer surface 164 may comprise pocket 161, camera-window 165, and label 162. Pocket 161 may comprise volume 210, useful for retaining credit card 211 (FIG. 1), money 212, and alternately a set of keys 213. Label 162 may comprise indicia 200. Indicia 200 may comprise personalized labeling 202, useful for ready identification of user 140 (FIG. 1) of cell phone 120 (FIG. 1). Further, outer surface 164 may comprise protective-materials 201 useful for protecting cell phone 120 from damage when dropped.

In continuing to refer to FIG. 4, cell phone receiver 160 may be able to comprise plurality of colors 220, useful for aesthetic pleasure of user 140. Cell phone receiver 160 may further comprise plurality of designs 221, useful for ready recognition of proximity of user 140 of cell phone 120. Upon reading this specification, it should be appreciated that, under appropriate circumstances, considering such issues as user preferences, design preference, structural requirements, marketing preferences, cost, available materials, technological advances, etc., other cell phone case with pocket assembly arrangements such as a plurality of pockets, a plurality of sizes to accommodate a plurality of types of mobility devices, elastomeric materials, including external power charging devices, etc., may be sufficient.

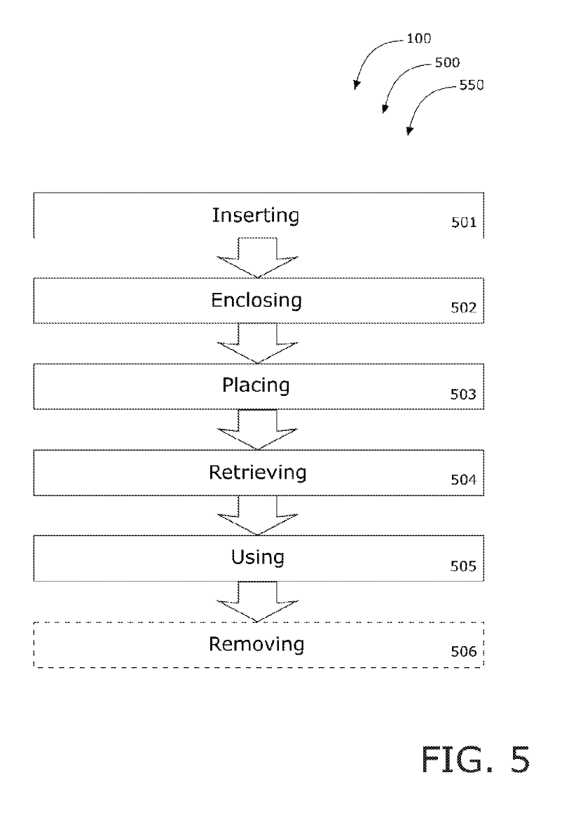

Referring now to FIG. 5 showing flowchart 550 illustrating method of use 500 for cell phone case with pocket system 100 according to an embodiment of the present invention of FIGS. 1-4. As shown, method of use 500 may comprise the steps of: step one 501, inserting cell phone 120 in cell phone receiver 160; step two 502, enclosing cell phone 120 with cell phone cover 180; step three 503, placing credit card 211, money 212, and alternately a set of keys 213 in pocket 161; step four 504, retrieving credit card, 211, money 212, and alternately a set of keys 213 from pocket 161 as desired; step five 505, using cell phone 120 for communications; and step six 506, removing cell phone 120 from cell phone case with pocket assembly 110 when desired.

It should be noted that step 506 is an optional step and may not be implemented in all cases. Optional steps of method of use 500 are illustrated using dotted lines in FIG. 5 so as to distinguish them from the other steps of method of use 500.

It should be noted that the steps described in the method of use can be carried out in many different orders according to user preference. The use of “step of” should not be interpreted as “step for”, in the claims herein and is not intended to invoke the provisions of 35 U.S.C. §112(f). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A cell phone case system comprising:
a cell phone receiver that includes:
an inner volume and
an outer surface, the outer surface further including
a pocket opening to the inner volume, and
a camera-window; and
a cell phone cover that includes:
a transparent window, and
cell phone tactile-function-enabling-materials, and
wherein said cell phone receiver and said cell phone cover are structured and arranged in combination to removably enclose a cell phone in a waterproof closure while allowing a user to store a plurality of items in said pocket.

2. The cell phone case of claim 1, wherein said inner volume of said cell phone receiver has a depth.

3. The cell phone case of claim 2, wherein said inner volume of said cell phone receiver has a width.

4. The cell phone case of claim 3, wherein said inner volume of said cell phone receiver has a height.

5. The cell phone case of claim 4, wherein said depth, said width, and said height of said inner volume are structured and arranged to removably couple with said cell phone.

6. The cell phone case of claim 1, wherein said outer surface includes protective-materials configured to protect said cell phone from damage when dropped.

7. The cell phone case of claim 1, wherein said pocket has a volume arranged to retain at least one of a credit card, money, and a set of keys.

8. The cell phone case of claim 1, wherein said camera window includes a clear lens, configured to allow said user to take photographs when said outer surface is coupled with said cell phone.

9. The cell phone case of claim 1, wherein said label includes indicia.

10. The cell phone case of claim 9, wherein said indicia includes personalized labeling, configured to provide ready identification of said user of said cell phone.

11. The cell phone case of claim 1, wherein said cell phone cover is removably attachable to said cell phone receiver, and configured to provide said waterproof enclosure for said cell phone.

12. The cell phone case of claim 1, wherein said cell phone cover, in an installed condition, is in parallel configuration to said cell phone.

13. The cell phone case of claim 1, wherein said transparent window comprises see-through-plastic-materials, configured to allow said user to view one or more displays on said cell phone.

14. The cell phone case of claim 1, wherein said cell phone tactile-function-enabling-materials include an interface for said user to access said cell phone.

15. The cell phone case of claim 1, wherein said cell phone receiver is configured to include a plurality of colors.

16. (canceled)

17. A cell phone case comprising:
a cell phone receiver having
an inner volume and
an outer surface including
a pocket opening to the inner volume,
a camera-window, and
a label; and
a cell phone cover including
a transparent window and
cell phone tactile-function-enabling-materials,
wherein said inner volume of said cell phone receiver includes a depth, a width, and a height, said depth, width, and height being structured and arranged to removably couple with said cell phone;
wherein said outer surface further comprises protective-materials configured to protect said cell phone from damage when dropped;
wherein said pocket assembly includes a volume configured to retain at least one of a credit card, money, and a set of keys;
wherein said camera window includes a clear lens configured to allow, a user to take photographs when said outer surface is coupled with said cell phone;
wherein said cell phone receiver and said cell phone cover are structured and arranged in combination to removably enclose said cell phone in a waterproof closure while allowing said user to store a plurality of items in said pocket and apply said label with indicia.

18. The cell phone case with pocket system of claim 17, further comprising
a set of user instructions;
wherein said cell phone case with pocket assembly and the set of user instructions are arranged as a kit.

19-20. (canceled)

21. The cell phone case of claim 1, wherein the waterproof closure is configured to buoy the cellphone in water.

22. A cellphone case comprising:
a cell phone receiver having an inner volume and an outer surface, the outer surface defining a pocket opening that accesses a pocket within the inner volume; and
a transparent cell phone cover configured to removably engage the cell phone receiver thereby forming the inner volume,
wherein said inner volume of said cell phone receiver includes a depth, a width, and a height structured and arranged to receive and watertightly hold an object.
